(19) United States
(12) Patent Application Publication
(10) Pub. No.: US 2022/0222695 A1
(43) Pub. Date: Jul. 14, 2022

(54) CONTENT COMMUNICATIONS SYSTEM WITH CONVERSATION-TO-TOPIC MICROTREND MAPPING

(71) Applicant: MASTERCARD INTERNATIONAL INCORPORATED, Purchase, NY (US)

(72) Inventors: Abhijit SHOME, Fort Lee, NJ (US); Guillaume Jean Francois CONTEVILLE, Mamaroneck, NY (US); Venkata R. MADABHUSHI, Cincinnati, OH (US); Michele MCCRAY-HOWARD, Valley Stream, NY (US); Rukuma VIEGAS, New York, NY (US); Sourojit BHADURI, Jamshedpur (IN); Yatin KATYAL, Rohtak (IN)

(21) Appl. No.: 17/319,824

(22) Filed: May 13, 2021

(30) Foreign Application Priority Data
Jan. 13, 2021 (IN) 202111001702

(51) Int. Cl. G06Q 30/02; G06F 16/2457; G06Q 50/00; H04L 29/08; G10L 15/22; G10L 15/18; G06F 40/30; G06F 40/279; G06F 40/263

(52) U.S. Cl. CPC G06Q 30/0205; G06F 16/24575; G06Q 30/0201; G06Q 50/01; H04L 67/26; G10L 15/22; G06N 20/00; G06F 40/30; G06F 40/279; G06F 40/263; G06Q 30/0256; G06Q 30/0269; G06Q 30/0261; G10L 15/1815

(57) ABSTRACT

An artificial intelligence (AI)-based content communications system leverages microtrends identified from conversations in real-time to support targeted content mapped to the identified microtrends. The communications system receives conversation information of participants, including text of conversation, timestamp, and, optionally, geographical information, from a listening service authorized to capture the conversation information; determines one or more topic microtrends having above-threshold activity; retrieves content with tags having generated keywords associated with a corresponding topic microtrend; and generates a message comprising the content and, optionally, a topic microtrend dashboard to provide to an identified contact associated with the topic microtrend. In some cases, the content is directly pushed to a social media handle associated with the content.

### BACKGROUND

Digital marketing involves directing content to consumers via a variety of communication channels, including social media, messaging technology (e.g., short message service (SMS), multimedia messaging service (MMS)), e-mail, and websites. Identifying population segments for particular content is an area of considerable effort and research. Location-based targeted advertising is one approach to determining relevant content. For example, a consumer may be exposed to content indicating a sale at a particular merchant location when they are determined to be near that particular merchant location. In addition, with the availability of tracking (e.g., website cookies) and listening (e.g., digital virtual assistants) services, consumers can be assigned to population segments for directed advertising based on what they search, write, or say. However, consumers may be exposed to hundreds (or more) marketing messages per day. Research shows consumers may only remember two of these messages the next day. Thus, there exists a need for a system that can determine near real-time, relevant content.

### BRIEF SUMMARY

A content communications system with conversation-to-topic microtrend mapping is provided. The described content communications system can provide an artificial intelligence (AI)-based digital marketing solution that leverages microtrends in real-time.

An AI-based content communications system receives conversation information of participants, including text of conversation, timestamp, and, optionally, geographical information, from a listening service authorized to capture the conversation information; determines one or more topic microtrends having above-threshold activity; and retrieves content with tags having generated keywords associated with a corresponding topic microtrend.

The content communications system generates the keywords for topics using AI and machine learning that can train on corpuses including the conversation information.

The microtrends identified from the conversations can be used to support digital marketing and social media presence mapped to the identified microtrends. For example, the content communications system can generate a message comprising the content and optionally generate a topic microtrend dashboard to provide to an identified contact associated with the topic microtrend. The topic microtrend dashboard can be generated using robotic process automation that stitches together one or more of data, digital assets, trends, key conversations, conversation emotions, demographics, etc. for an identified topic microtrend. In some cases, the content is directly pushed to a social media handle associated with the content with the tags having the generated keywords associated.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates conversation-to-topic microtrend mapping for targeted content communication.

FIG. 2 illustrates a process flow diagram for a content communications system with conversation-to-topic microtrend mapping.

FIG. 3 illustrates a content communications system with conversation-to-topic microtrend mapping.

FIG. 4 illustrates an example operating environment and example implementation of a content communications system with conversation-to-topic microtrend mapping.

FIGS. 5A-5C illustrate features of an example topic microtrend dashboard.

FIGS. 6A-6C illustrate features of another example topic microtrend dashboard.

### DETAILED DESCRIPTION

A content communications system with conversation-to-topic microtrend mapping is provided. The described content communications system can provide an artificial intelligence (AI)-based digital marketing solution that leverages microtrends in real-time.

As used herein “microtrend” refers to a subject (or topic) that is having increasing “chatter” (or other activity), for example, via print and social media and/or via person-to-person conversations. The trend is considered “micro” because of limitations on the activity with respect to that subject, including, but not limited to, level of activity (e.g., numbers of people involved, numbers of times mentioned, numbers of conversations mentioning the subject/topic), regional limitations (e.g., city, state, country), language limitations (e.g., English or Italian), and time (e.g., amount of time that the subject is active).

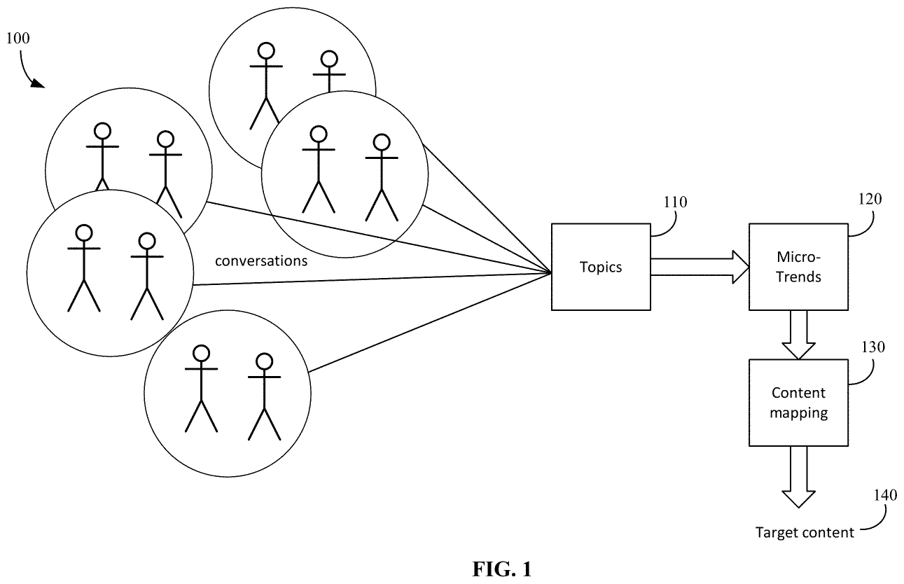

FIG. 1 illustrates conversation-to-topic microtrend mapping for targeted content communication. Referring to FIG. 1, conversations 100 between consenting participants can be captured, for example via listening services, which convert the spoken words of the participants into text (e.g., using speech-to-text/speech recognition technologies). The use of listening services as contemplated herein is done with the full authorization and consent of the participants. A content communications system performs conversation-to-topic microtrend mapping by identifying topics (110) in the conversations and determining micro-trends (120) from those topics. Content that is relevant to the topics associated with the determined micro-trends can be identified (130) (e.g., content-to-keyword mapping and other tools). The identified content can then be provided as target content (140) from the content communications system.

The content communications system can be used as part of an AI-based digital marketing solution. The particular topics of interest for identifying microtrends can be based on listening profiles. A listening profile refers to the topics, categories, and terms about which an entity may be interested in knowing how people are thinking about. For example, a listening profile may include a brand or product or service as its terms or topic. Similar to the concept of “social listening,” one purpose of a listening profile is to identify both mentions/engagement and sentiment/mood. However, instead of solely manually created profiles (e.g., user-specified), listening profiles may be identified from data based on social usage using Natural Language Processing (NLP) in multiple languages. The content communications system has the ability to improve the listening profiles via Machine Learning (ML) and human feedback.

The described technology identifies relevant micro-trends in real-time. The content communications system can generate insights using Robotic Process Automation (RPA), simulating a human drawing insight from tens of thousands of conversations in a matter of minutes. The RPA approach not just saves manual efforts of almost weeks but is also able to capture language and geographical-based trends in conversations. The identified microtrend can then be used to filter information for a particular consumer based on the microtrends identified for that consumer. For example, data, digital assets, trends, key conversations, conversation emotions, demographics etc., can be stitched together as target content using RPA in a single email. Generating an insight for a single micro-trend manually would take multiple days; however, with the described communications system, it is possible to generate hundreds (or more) of these insights daily. A marketer can launch a social media campaign in a matter of minutes, enabling real-time action (and not too late for when the trend has already waned). The content for the ad, including images is ready for use by the marketer. The post/ad can now be showcased to relevant consumers at the time when they are having these conversations and the topic is relevant and important to them.

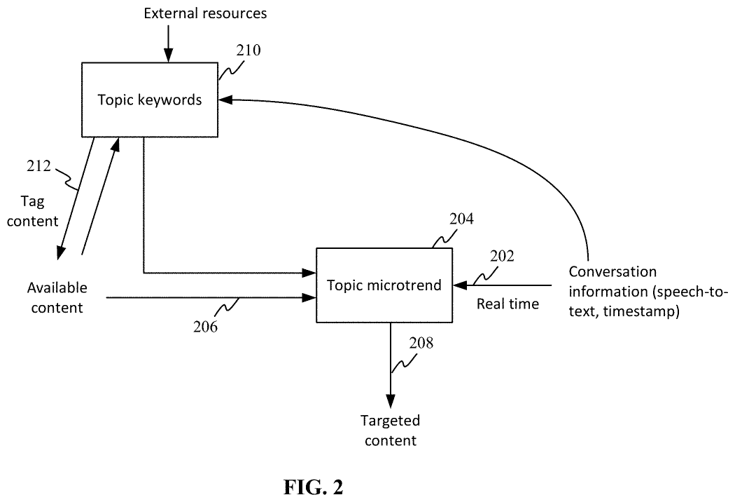

FIG. 2 illustrates a process flow diagram for a content communications system with conversation-to-topic microtrend mapping. Targeted content communication can be achieved by receiving (202) conversation information of participants, including text of conversation and a timestamp, from a listening service authorized to capture the conversation information; determining (204), from the conversation information, one or more topic microtrends having above-threshold activity; and retrieving (206), from a repository of available content, content with tags having one or more generated keywords associated with a corresponding topic microtrend.

A listening service may include a speech-to-text feature or a separate speech-to-text service may be used to convert the audio conversation to the text of conversation with the timestamps before the content communications system receives the conversation information. The timestamps may be based on the frame interval for the speech to text conversion or may be based on when a segment of the text of conversation is captured. The timestamp information is used by the content communications system to help identify frequency of a topic over time.

When the content communications system is determining the one or more topic microtrends having above-threshold activity, the threshold level for activity used to determine whether a topic is can be a predetermined level or can be based on a difference from a baseline level of activity (e.g., mentions) for that topic. For example, the determining (204) of the one or more topic microtrends having above-threshold activity can include identifying topics of conversation using natural language processing in a corresponding language; calculating usage for each identified topic within a period of time; and assigning a particular identified topic as a topic microtrend when the usage of satisfies the threshold level.

After retrieving content with tags having one or more generated keywords associated with a particular topic microtrend, targeted content can be output (208) by generating a message comprising the content for delivery to an identified contact associated with the topic microtrend, generating a topic microtrend dashboard comprising digital assets, trends, key conversations, conversation emotions, demographics, or a combination thereof, for an identified topic microtrend, performing a push operation of at least one retrieved content to a social media handle associated with the content with the tags having the one or more generated keywords, or a combination of two or more of these three types of output.

The conversation information of participants can further include geographical information. The determining of the one or more topic microtrends can thus be performed for each geographical region of a set of geographical regions. This enables geographically relevant content and experiences. Similarly, the determining of the one or more topic microtrends can be performed according to a language of the text of conversation. For example, topic microtrends in French may be different than those in Portuguese.

As mentioned above, content in the available content repository has tags based on generated keywords. The keywords that are associated with various topic microtrends can be generated (210) asynchronously from the topic microtrend determination. Content in the repository can be tagged (212) with appropriate generated keywords.

Keywords can be generated (210) by extracting conversation keywords from the conversation information, extracting content keywords from the available content, generating category-based keywords for the available content, and generating additional keywords having semantic similarity to the conversation keywords, the content keywords, and the category-based keywords. The generated keywords can be filtered in a machine learning-based keyword feedback process. Keywords can also be translated into a region's local language.

In some cases, the extracting of content keywords from the conversation information and/or the available content (e.g., experience description) can include a named entity recognition (NER) approach to extract keywords from text. For example, a NER model can be trained using a bidirectional Long Short-Term Memory with Conditional Random Field layer (BiLSTM-CRF) neural network architecture.

In some cases, the extracting of content keywords from the conversation information and/or the available content can include a graph-based approach to extract keywords from text. For example, an open-source python-based keyphrase extraction (PKE) can be used. Here, nodes are words of certain parts of speech and edges represent co-occurrence relations that are controlled by the distance between word occurrences. The nodes can be ranked by a TextRank graph-based ranking algorithm in its unweighted variant.

In some cases, the extracting of content keywords from the conversation information and/or the available content can include an unsupervised keyword extraction method such as YAKE (yet another keyword extractor), which supports texts of different sizes, domain, and languages. YAKE generates statistical features extracted from the text itself. These features, which can include casing, word position, and word frequency, are used to select the most relevant keywords from the text. The statistical features are combined in a complex scoring function used to yield the ranked key phrases.

In some cases, the generation of category-based keywords can be based on categories of product experiences. These keywords can be generated by including verbs (based on the category of the experience) with the words extracted from the content itself.

In some cases, the generating of additional keywords having semantic similarity can include using embeddings (e.g., Word2Vec embeddings) to generate keywords. Ontologies can also be used.

Filtering of keywords can be performed to refine the set of generated keywords. In some cases, certain words are filtered out based on similarity and certain words are filtered out based on dissimilarity. In some cases, when filtering out words based on similarity, Word Mover's Distance is used to create clusters of keywords based on a particular threshold of similarity between keywords. A few keywords are picked out of each cluster based on a heuristic, the rest of the keywords are removed, and the process is applied to each keyword group separately. In some cases, when filtering out words based on dissimilarity, Isolation Forest and One Class State Vector Machine (SVM) are used on the remaining keywords to remove keywords that were a lot dissimilar to the corpus of keywords generated. The process is separately applied to each keyword group. The frame of reference can be from the available content (e.g., the experience description). The remaining keywords after the process is applied are the final generated keywords.

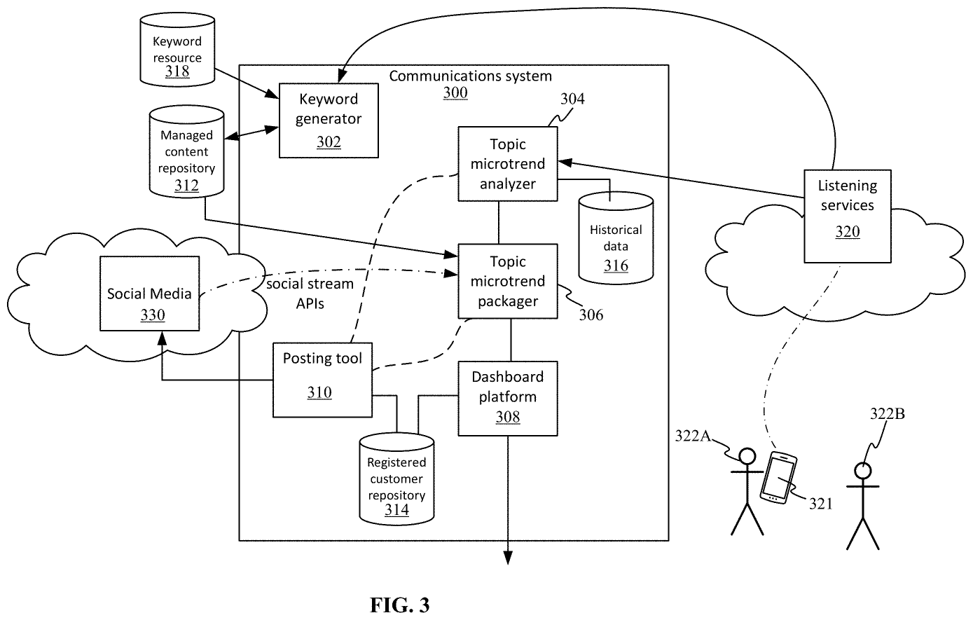

FIG. 3 illustrates a content communications system with conversation-to-topic microtrend mapping. Referring to FIG. 3, communications system 300 can include a keyword generator 302, a topic microtrend analyzer 304, a topic microtrend packager 306, a dashboard platform 308, and an automated posting tool 310, each of which may be in the form of stored software (e.g., that can be executed by a general hardware processor), hardware, or a combination of stored software and hardware (e.g., dedicated hardware processor to execute the stored software). Communications system 300 can further include or communicate with storage resources such as a managed content repository 312, registered customer repository 314, historical data resource 316, and keyword resource 318.

Accordingly, the communications system 300 can include one or more processing systems, one or more storage resources, and a communications interface (e.g., network interface). The one or more processing systems are hardware that can include central processing units (CPUs), graphics processing units (GPUs), field programmable gate arrays (FPGAs), and/or any other suitable processing logic and devices. The one or more processing systems can be used to implement and/or execute the keyword generator 302, topic microtrend analyzer 304, topic microtrend packager 306, dashboard platform 308, and automated posting tool 310, including one or more neural networks and/or artificial intelligence applications. The one or more storage resources (e.g., for managed content repository 312, registered customer repository 314, historical data resource 316, and keyword resource 318) can include any suitable storage media. As used herein, “storage media” and “storage medium” do not consist of transitory propagating signals. The one or more storage resources can be used to store structured data such as described with respect to managed content repository 312, registered customer repository 314, historical data resource 316, and keyword resource 318; as well as store executable instructions for performing the processes described herein, including associated with the keyword generator 302, topic microtrend analyzer 304, topic microtrend packager 306, dashboard platform 308, and automated posting tool 310. The communications interface can include any suitable systems and devices that enable the communications system to communicate with other computing systems over a network as well as any distributed components of the communications system. For example, the communications interface enables the communications system 300 to communicate with listening services 320 and social media platforms 330 via appropriate application programming interfaces (APIs).

Listening services 320 include virtual digital assistant services and other audio-capture and/or speech-to-text applications that can capture via a local device 321, upon authorization and consent of participants 322A, 322B, conversation of the participants. The conversation information of the participants can have any personal identifiable information removed before receipt by the content communications system such that just the text of the conversation, time of the conversation, and optionally geographic location (of varying granularity) remains.

The managed content repository 312 can be a structured data resource providing a mapping of keywords to available content. The managed content repository 312 includes available content (or the locations of the available content when stored separately) and associated metadata (including keywords). The available content can include experience descriptions such as available from MASTERCARD PRICELESS, which includes experiences in interest categories such as entertainment, arts and culture, sports, culinary, travel, and shopping; and location categories such as in the Asia Pacific, Europe, Latin America, Middle East/Africa, and North America. A content manager for the managed content repository 312 may be part of the communications system 300 or a separate system that manages the existing available content.

The registered customer repository 314 stores information and preferences of customers utilizing the services of the communications system 300. In some cases, the registered customer repository 314 maps customer contacts to topics, regions, and other preferences used to generate and deliver topic microtrend packages. In some cases, the registered customer repository 314 includes information enabling the communications system 300 to post content to a customer's social media handle.

Historical data resource 316 stores conversation information received from listening services 320 as well as various information identified from the topic microtrend analyzer 304. Historical data in the historical data resource 316 can be used to assist with identifying trends over time and, in some cases, can be used as training data/self-learning data for machine learning processes (e.g., to identify listening profiles, to generate keywords).

Keyword resource 318 can store generated keywords. In some cases, the keyword resource 318 is part of the managed content repository 312.

Keyword generator 302 can receive conversation information from listening services 320, available content in the managed content repository 312, as well as other resources such as ontology databases, dictionaries, search engines, etc.; and can perform processes for keyword generation and optimization such as described with respect to operation 210 of FIG. 2.

Topic microtrend analyzer 304 can receive conversation information from listening services 320 and keywords from the keyword resource 318 to identify topic microtrends, such as described with respect to operation 204 of FIG. 2. Microtrend analyzer 304 can incorporate RPA to perform the microtrend identification.

Topic microtrend packager 306 can receive the identified topic microtrends from the topic microtrend analyzer 304, available content from the managed content repository 312, and stream data from various social media platforms to generate a topic microtrend-specific message or dashboard. The topic microtrend packager 306 can utilize robotic process automation to generate and aggregate relevant information. Topic microtrend packager 306 can perform processes such as described with respect to operation 208 of FIG. 2.

Dashboard platform 308 can receive the topic microtrend-specific message or dashboard from the topic microtrend packager 306 and determine which customer receives a particular package (i.e., the message/dashboard) based on customer preferences indicated by the registered customer repository 314 (or based on a user-input when provided in response to a specific request such as via a website).

Automated posting tool 310 can be part of the topic microtrend packager 306 or an independent tool that can post an available content retrieved for a particular topic microtrend to social media 330 with an appropriate social media handle as identified by the registered customer repository 314. The automated posting tool 310 performs automated content delivery to a social media platform on behalf of the appropriate social media handle. The automated posting tool 310 can be used to post a package created by the topic microtrend packager 306. The posting by the automated posting tool 310 can be performed based on predetermined rules and/or in response to approval of the particular package. That is, in some cases, explicit user approval for a particular posting (or group of postings) is required before the tool posts the content to the social media handle.

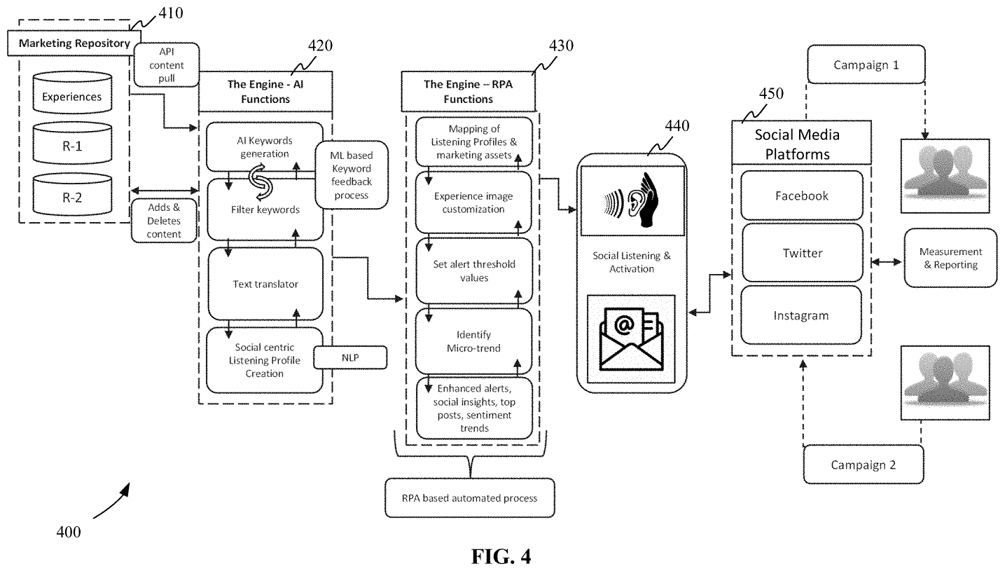

FIG. 4 illustrates an example operating environment and example implementation of a content communications system with conversation-to-topic microtrend mapping. Referring to FIG. 4, an operating environment 400 includes a marketing repository 410; processing system 420 for AI functions, such as keyword generation and keyword filtering (such as described above with respect to process 210), text translation, and listening profile creation (using, for example, natural language processing); and processing system 430 for RPA, such as mapping listening profiles and marketing assets, providing experience image customization, setting alert threshold values, identifying topic microtrends, and generating enhanced alerts, social insights, top posts, and sentiment trends. Processing system 420 can pull content from the marketing repository via application programming interfaces (APIs) and add and delete content to marketing repository 410. Information, such as keywords and listening profiles from processing system 420, can be used by processing system 430 to carry out certain processes as described herein. Processing system 430 can communicate with social listening and activation services 440 and various communication channel/platforms, including social media platforms 450.

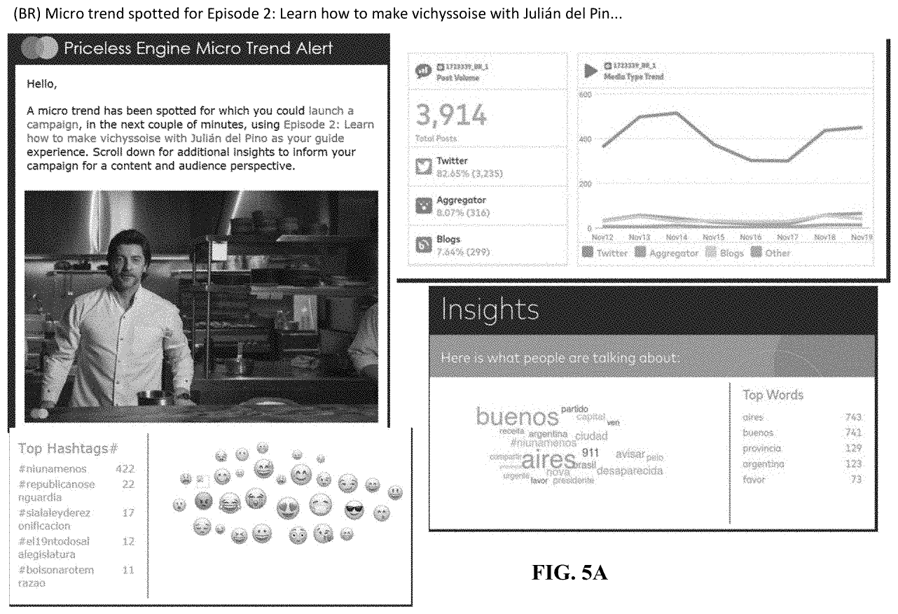

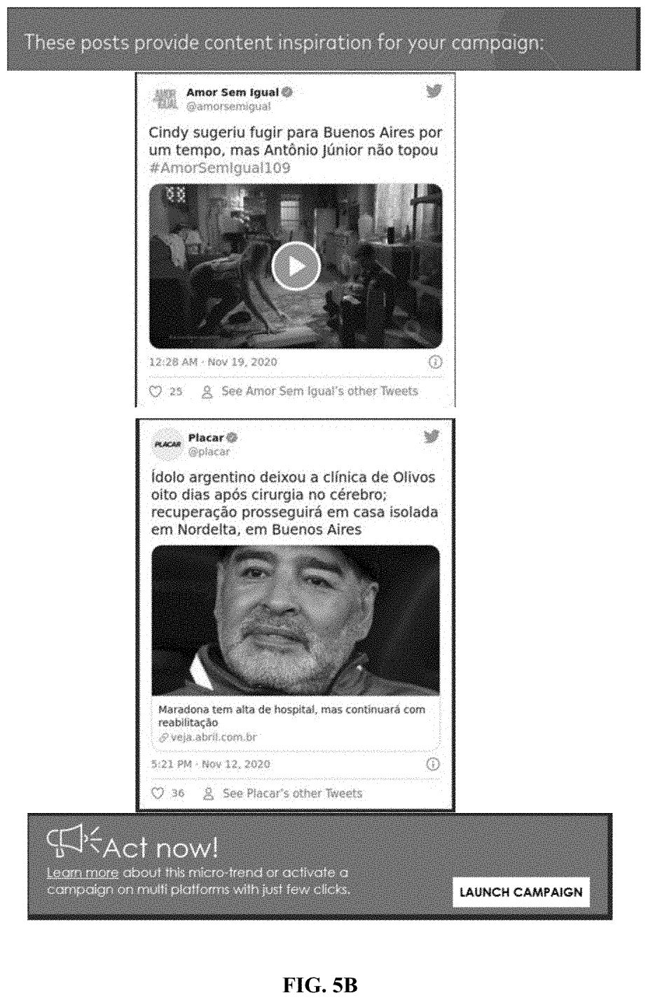

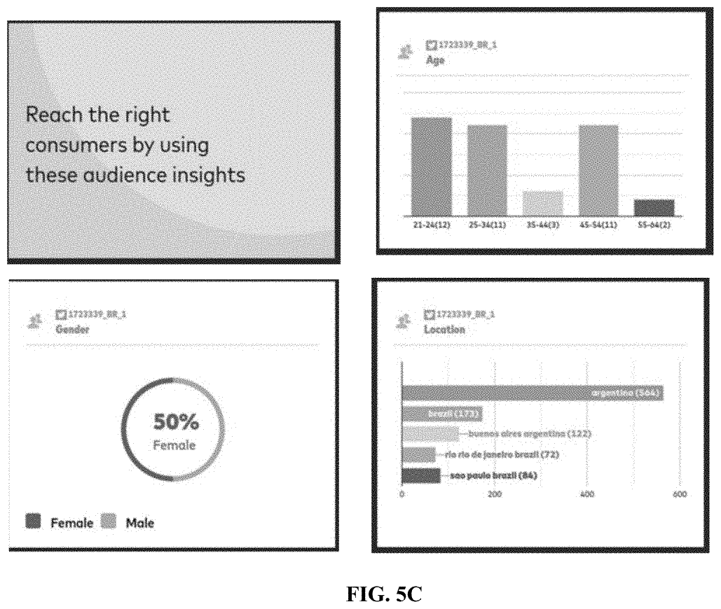

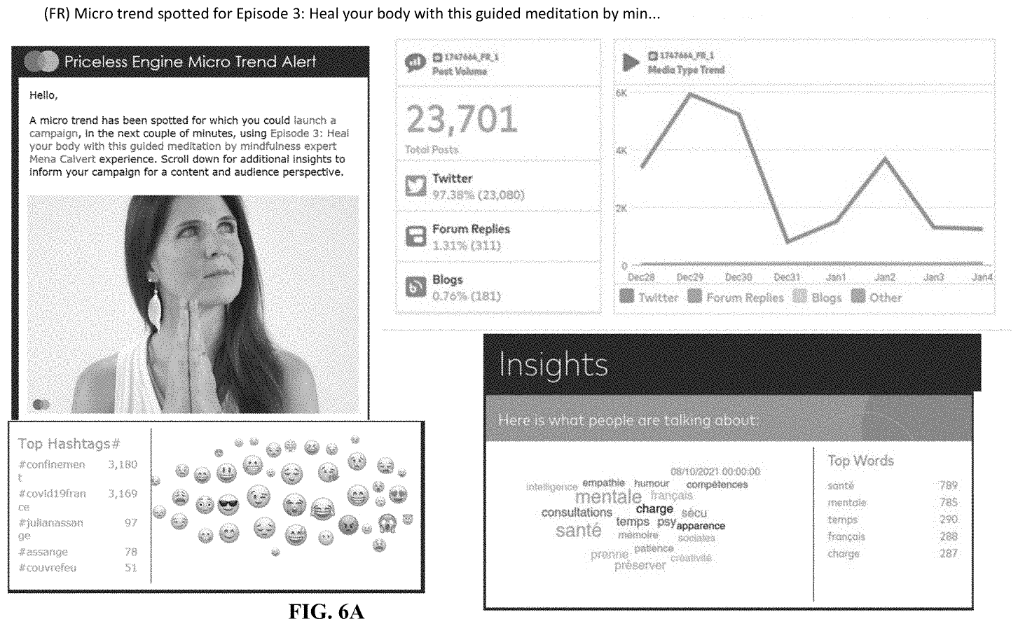

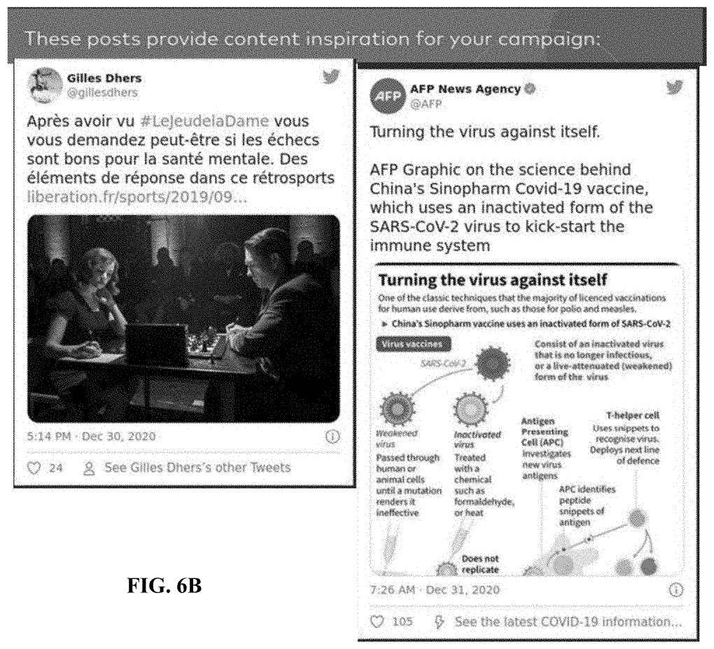

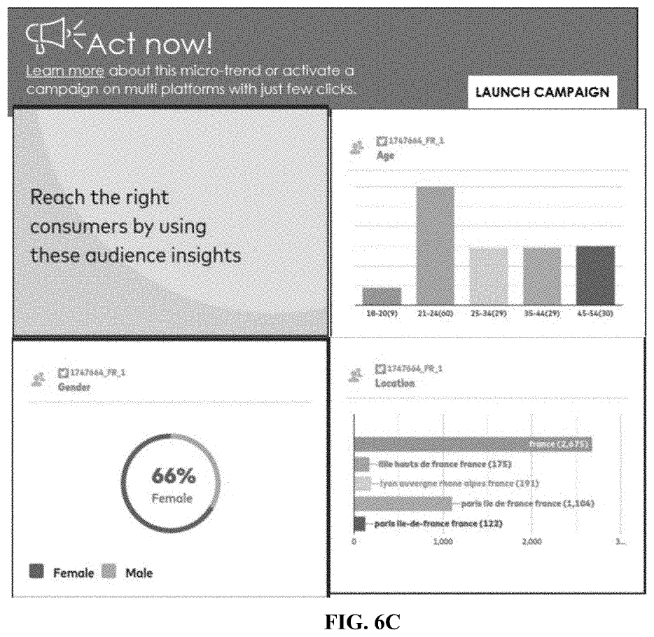

FIGS. 5A-5C illustrate features of an example topic microtrend dashboard; and FIGS. 6A-6C illustrate features of another example topic microtrend dashboard.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method for targeted content communication, comprising:
receiving conversation information of participants, including text of conversation and a timestamp, from a listening service authorized to capture the conversation information;
determining, from the conversation information, one or more topic microtrends having above-threshold activity; and
retrieving, from a repository of available content, content with tags having one or more generated keywords associated with a corresponding topic microtrend.

2. The method of claim 1, further comprising:
generating a message comprising the content for delivery to an identified contact associated with the corresponding topic microtrend.

3. The method of claim 1, further comprising:
generating a topic microtrend dashboard comprising digital assets, trends, key conversations, conversation emotions, demographics, or a combination thereof, for an identified topic microtrend.

4. The method of claim 1, further comprising:
performing a push operation of at least one retrieved content to a social media handle associated with the content with the tags having the one or more generated keywords.

5. The method of claim 1, wherein the conversation information further comprises geographical information.

6. The method of claim 5, wherein the determining of the one or more topic microtrends is performed for each geographical region of a set of geographical regions.

7. The method of claim 1, wherein the determining of the one or more topic microtrends is performed according to a language of the text of conversation.

8. The method of claim 1, wherein the determining of the one or more topic microtrends having above-threshold activity comprises:
identifying topics of conversation using natural language processing in a corresponding language;
calculating usage for each identified topic within a period of time; and
assigning a particular identified topic as a topic microtrend when the usage satisfies a threshold level.

9. The method of claim 1, further comprising:
generating the one or more generated keywords by extracting conversation keywords from the conversation information, extracting content keywords from the available content, generating category-based keywords for the available content, and generating additional keywords having semantic similarity to the conversation keywords, the content keywords, and the category-based keywords.

10. A content communications system, comprising:
one or more processing systems;
one or more storage resources;
a communications interface; and
instructions stored on at least one of the one or more storage resources, that when executed by at least one of the one or more processing systems, direct the content communications system to:
receive conversation information of participants, including text of conversation and a timestamp, from a listening service authorized to capture the conversation information;
determine, from the conversation information, one or more topic microtrends having above-threshold activity;
retrieve, from a repository of available content, content with tags having one or more generated keywords associated with a corresponding topic microtrend; and
output targeted content including the content with the tags having the one or more generated keywords associated with the corresponding topic microtrend.

11. The content communications system of claim 10, wherein the instructions to output the targeted content direct the content communications system to:
generate a message comprising the content for delivery to an identified contact associated with the corresponding topic microtrend.

12. The content communications system of claim 10, wherein the instructions to output the targeted content direct the content communications system to:
generate a topic microtrend dashboard comprising digital assets, trends, key conversations, conversation emotions, demographics, or a combination thereof, for an identified topic microtrend.

13. The content communications system of claim 10, wherein the instructions to output the targeted content direct the content communications system to:
perform a push operation of at least one retrieved content to a social media handle associated with the content with the tags having the one or more generated keywords.

14. The content communications system of claim 10, wherein the conversation information further comprises geographical information.

15. The content communications system of claim 14, wherein the instructions to determine, from the conversation information, the one or more topic microtrends having above-threshold activity direct the content communications system to determine microtrends for each geographical region of a set of geographical regions.

16. The content communications system of claim 10, wherein the one or more topic microtrends are determined according to a language of the text of conversation.

17. The content communications system of claim 10, wherein the instructions to determine the one or more topic microtrends having above-threshold activity direct the content communications system to:
identify topics of conversation using natural language processing in a corresponding language;
calculate usage for each identified topic within a period of time; and
assign a particular identified topic as a topic microtrend when the usage of satisfies a threshold level.

18. The content communications system of claim 10, further comprising instructions that direct the content communications system to:
generate the one or more generated keywords by extracting conversation keywords from the conversation information, extracting content keywords from the available content, generating category-based keywords for the available content, and
generate additional keywords having semantic similarity to the conversation keywords, the content keywords, and the category-based keywords.

19. The content communications system of claim 18, further comprising instructions that direct the content communications system to:
tag the available content in the repository of available content with appropriate keywords of the generated keywords and generated additional keywords.
